(19) United States
(12) Patent Application Publication
(10) Pub. No.: US 2023/0020103 A1
(43) Pub. Date: Jan. 19, 2023

(54) INDUCTION TOBACCO HEATER

(71) Applicant: I.R.C.A. S.P.A. INDUSTRIA RESISTENZE CORAZZATE E AFFINI, Vittorio (IT)

(72) Inventors: Francesco GIUSTO, Mestre (IT); Stefano ZANELLA, Montebelluna (IT); Federico ZOPPAS, Treviso (IT)

(21) Appl. No.: 17/781,927

(22) PCT Filed: Dec. 11, 2020
(86) PCT No.: PCT/IB2020/061816

§ 371 Date: Jun. 2, 2022

(30) Foreign Application Priority Data
Dec. 11, 2019 (IT) 102019000023649

(51) Int. Cl. A24F 40/465; H05B 6/36; H05B 6/10; H01F 27/32; H01F 41/061; A24F 40/20; A24F 40/51; A24F 40/70

(52) U.S. Cl. CPC A24F 40/465; H05B 6/36; H05B 6/105; H01F 27/32; H01F 41/061; A24F 40/20; A24F 40/51; A24F 40/70

(57) ABSTRACT

An induction heater for a device for heating tobacco or aromatic herbs, in particular of the heat-not-burn type. The induction heater includes at least one inductor having at least one electrically insulating layer and at least one electrically conductive track fixed to the at least one electrically insulating layer. The at least one inductor is adapted to be arranged about a metal tube in which part of a cigarette can be inserted, and the metal tube is adapted to be heated by induction by the at least one inductor.

### FIELD OF THE INVENTION

The present invention relates to the field of heaters for devices for heating tobacco or aromatic plants or aromatic herbs (dry herbs), in particular for devices of the heat-not-burn type.

### BACKGROUND ART

Recently, devices have spread on a large scale which heat tobacco or aromatic herbs without causing the combustion thereof. Such devices are therefore known as heat-not-burn. Tobacco heating devices may, for example, heat the tobacco contained in a cigarette, or, in more general terms, the tobacco contained in a wrapper, conventionally made of paper.

Important aspects of the heaters of such devices are the speed, effectiveness and efficiency of the heating, as well as aspects relating to the safety of the device, such as, for example, the prevention of unwanted overheating. It is also important that the heaters of such devices are compact, in particular that they are very thin, and that they may be manufactured at low cost. A further important aspect relates to the homogeneity of the temperature during the heating step.

Manufacturing a heater for a tobacco heating device combining the above aspects is not trivial.

The need is therefore felt for a heater for a tobacco heating device which is improved with respect to known heaters.

### SUMMARY OF THE INVENTION

It is an object of the present invention to manufacture an induction heater for a tobacco heating device, which allows to reduce the time required to heat the tobacco.

It is another object of the present invention to manufacture an induction heater for a tobacco heating device, which can be easily assembled.

It is another object of the present invention to manufacture an induction heater for a tobacco or aromatic herb heating device which allows an easier integration of sensors, in particular temperature sensors or sensors for detecting the presence of the wrapper containing tobacco or aromatic herbs.

The present invention achieves at least one of such objects, and other objects which will be evident in the light of the present description, by means of an induction heater for a device for heating tobacco or aromatic plants or herbs, in particular of the heat-not-burn type, comprising at least one inductor which comprises at least one electrically insulating layer and at least one electrically conductive track fixed to said at least one electrically insulating layer;

wherein said at least one inductor is adapted to be arranged about a metal tube in which may be inserted part of a cigarette or, optionally, a wrapper, in particular containing tobacco or aromatic plants or aromatic herbs;

whereby the metal tube is adapted to be heated by induction by said at least one inductor.

In particular, the inductor extends about an axis Y, preferably so as to define a tube or tubular body. Preferably, said at least one electrically conductive track has a thickness, parallel to a radial axis X, or perpendicular axis, with respect to axis Y, from 5 to 400 μm or from 10 to 400 μm.

The invention also relates to a device for heating tobacco or aromatic herbs, in particular of the heat-not-burn type, according to claim 23.

The induction heater according to the invention advantageously allows to reduce the time required to heat the tobacco; it can be easily assembled; it is energy efficient; and it is particularly thin.

Preferably, said at least one inductor of an induction heater according to the invention is made by deforming a flat inductor, so that it extends about an axis, in particular so as to define a tube.

Preferably, the induction heater comprises a channel which may be optionally crossed by a flow of fluid, in particular to cool the inductor.

According to a particular embodiment, the induction heater comprises a polymeric tube adapted to be arranged about said metal tube; and said at least one inductor is fixed to said polymeric tube; preferably to an external surface of said polymeric tube. Therefore, the inductor is preferably in contact, in particular directly in contact, with the polymeric tube.

Preferably, said polymeric tube is spaced apart from said metal tube.

Advantageously, a space, preferably an empty space, is preferably provided between the polymeric tube and the metal tube. Said space is preferably substantially a duct. Thereby, unwanted overheating of the inductor, caused by the heating of the metal tube, is avoided. Indeed, the space, preferably occupied by air, creates thermal insulation.

Preferably, the space between the metal tube and the polymeric tube may be crossed by a flow of fluid, for example, a flow of air or a flow of fluid generated by heating the tobacco. For example, the flow of air may both cool the inductor and be used to generate a flow of hot air (heated by the metal tube) which the user may inhale. Furthermore, the aforesaid space or channel may be crossed by the fluid which is generated by heating the tobacco, which may mix with a flow of air.

The polymeric tube advantageously allows the passage of the electromagnetic waves generated by the at least one inductor for heating the metal tube.

According to a particular embodiment, said at least one inductor is arranged about an axis, in particular so as to define a tube, and is preferably spaced apart from said metal tube.

Advantageously, a space, preferably an empty space, is preferably provided between the inductor and the metal tube. Said space is preferably substantially a duct. Thereby, unwanted overheating of the inductor, caused by the heating of the metal tube, is avoided. Indeed, the space, preferably occupied by air, creates thermal insulation.

Preferably, the space between the metal tube and the inductor may be crossed by a flow of fluid, for example, a flow of air or a flow of fluid generated by heating the tobacco. For example, the flow of air may both cool the inductor and be used to generate a flow of hot air (heated by the metal tube) which the user may inhale.

Furthermore, the aforesaid space or channel may be crossed by the fluid which is generated by heating the tobacco, which may mix with a flow of air.

According to a particular embodiment, said at least one inductor is fixed to said metal tube, in particular to an external surface of said metal tube. Preferably, said at least one inductor is in contact, in particular directly in contact, with the metal tube.

An advantage of this embodiment is given by the possibility of using the energy lost or dissipated on the inductor, which may therefore be used to recover energy, thus improving the energy efficiency of the heater.

Preferably, a duct is provided, for example, another tube, arranged about said at least one inductor and spaced apart from said at least one inductor.

Advantageously, a space, preferably an empty space, is preferably provided between said further tube and the inductor. Said space is substantially a duct.

Thereby, unwanted overheating of the inductor, caused by the heating of the metal tube, is avoided. Indeed, the space between said further tube and the inductor may be crossed by a flow of fluid, for example, a flow of air or a flow of fluid generated by heating the tobacco. For example, the flow of air may both cool the inductor and be used to generate a flow of hot air (heated by the metal tube) which the user may inhale. Furthermore, the aforesaid space or channel may be crossed by the fluid which is generated by heating the tobacco, which may mix with a flow of air.

The invention also relates to a process according to claim 24.

Further features and advantages of the invention will become more apparent in light of the detailed description of exemplary, non-exclusive embodiments.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a perspective view of a first example of an induction heater in accordance with the invention;

FIG. 2 shows a side view of the induction heater according to FIG. 1;

FIG. 3 shows the section A-A of the induction heater of FIG. 2;

FIG. 4 diagrammatically shows a section of an induction heater according to the first example;

FIG. 5 shows a perspective view of a second example of an induction heater in accordance with the invention;

FIG. 6 shows a side view of the induction heater according to FIG. 5;

FIG. 7 shows the section B-B of the induction heater of FIG. 6;

FIG. 8 diagrammatically shows a section of an induction heater according to the second example;

FIG. 9 shows a perspective view of a third example of an induction heater in accordance with the invention;

FIG. 10 shows a side view of the induction heater according to FIG. 9;

FIG. 11 shows the section C-C of the induction heater of FIG. 10;

FIG. 12 diagrammatically shows a section of an induction heater according to the third example;

FIG. 13 shows a top plan view of an inductor before being mounted in an induction heater in accordance with the invention;

FIG. 14 shows another example of an induction heater in accordance with the invention;

The same elements or parts have the same reference numerals.

### DESCRIPTION OF EXEMPLARY EMBODIMENTS OF THE INVENTION

With reference to the Figures, exemplary embodiments of an induction heater 101, 102, 103 for a device for heating tobacco or aromatic plants or herbs (dry herbs), in particular of the heat-not-burn type, are described.

The heating device may, for example, heat the tobacco, or aromatic herbs, contained in a cigarette, or, in more general terms, the tobacco, or aromatic herbs, contained in a wrapper, for example, made of paper.

The heating device is, in particular, an electrical or electronic device.

The induction heater 101, 102, 103 is preferably adapted to be arranged, at least partially, in the body of said heating device, said body being preferably distinct from the induction heater 101, 102, 103.

The induction heater 101, 102, 103 comprises at least one inductor 1. Said at least one inductor 1 comprises at least one electrically insulating layer 2, 3 and at least one electrically conductive track 4, or conductive track 4, fixed to said electrically insulating layer 2, 3. In particular, the electrically conductive track 4 adheres to said electrically insulating layer 2, 3, or in any case is preferably directly in contact with said at least one electrically insulating layer 2, 3.

Said at least one inductor 1 is adapted to be arranged about a metal tube 5 in which part of a cigarette may be inserted; whereby, in particular so that, the metal tube 5 is adapted to be heated by induction by said at least one inductor 1. The heat of the metal tube 5 can be transmitted to the tobacco, or to the aromatic herbs contained in the cigarette or in a wrapper. Preferably, the metal tube 5 is designed so that the internal surface thereof may go directly into contact with the wrapper containing the tobacco or aromatic herbs.

The inductor 1 extends about an axis Y.

In particular, said at least one electrically insulating layer 2, 3 extends around axis Y.

Said axis Y is, in particular, a rectilinear axis.

The inductor 1 preferably extends completely about axis Y.

Preferably, the inductor 1 is arranged about axis Y so as to define a tube, i.e., so as to form a tube, for example, cylindrical in shape. In particular, the wall or internal surface of the tube defined by the inductor 1 is defined by said at least one electrically insulating layer 2, 3, for example, by the electrically insulating layer 3.

The inductor 1 preferably has a height, in particular an overall height, parallel to axis Y, from 5 to 100 mm.

The metal tube 5 also extends preferably about said axis Y, i.e., the inductor 1 and the metal tube 5 are coaxial to one another.

The inductor 1 is preferably of the etched foil type. In particular, the inductor 1 is made by etching or laser cutting a metal sheet.

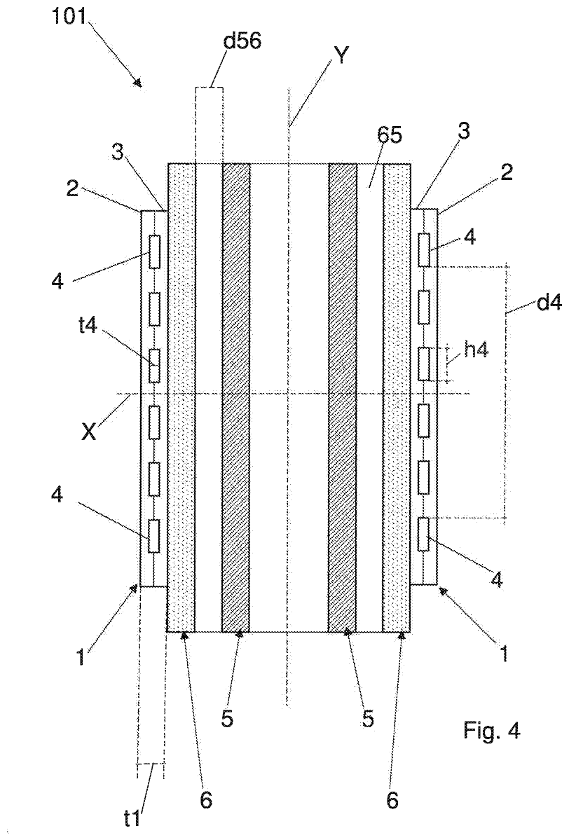

Preferably, the inductor 1 has a thickness t1 (FIG. 4, 8, 12) from 30 to 3000 μm or from 35 to 3000 μm; preferably from 30 to 500 μm or from 35 to 500 μm, preferably from 50 to 350 μm.

Such thickness t1 is measured, in particular, parallel to an axis X radial with respect to axis Y, in particular an axis X orthogonal to axis Y.

Said thickness t1 is, in particular, the thickness of the wall of the inductor 1, more in particular, it is the thickness of the wall of the tube or tubular body defined by the inductor 1.

The electrically conductive track 4, or conductive track, preferably has a thickness t4 (FIG. 4, 8, 12) from 5 to 400 μm or from 10 to 400 μm; preferably from 20 to 200 μm; preferably from 25 to 150 μm.

Such thickness t4 is measured, in particular, parallel to the aforesaid radial axis X.

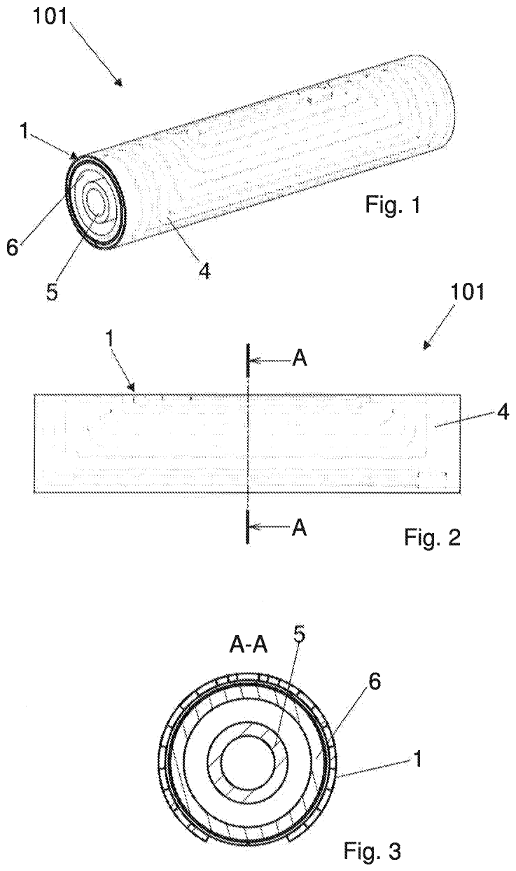

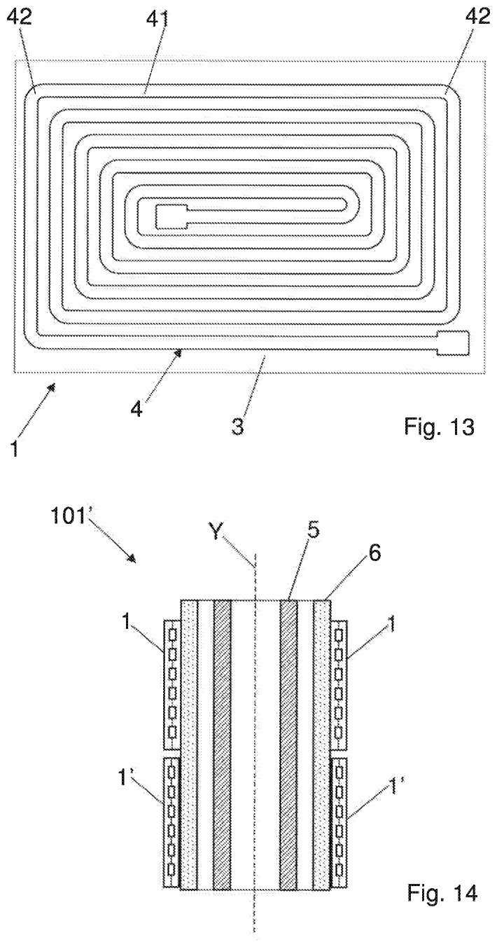

Preferably, the inductor 1 is flexible. In particular, the inductor 1 is a component which, considered alone, is flexible. “Flexible” means that the inductor 1 is adapted to be subjected to a deformation, in particular an elastic deformation, without breaking. For example, the inductor 1 may pass from the planar configuration, shown in FIG. 13, to the configuration in which it extends about axis Y (shown, for example, in FIG. 1).

The flexibility of the inductor 1 is a particularly advantageous feature, in particular for, but not limited to, the assembly of the induction heater.

The conductive track is, in particular, an element different with respect to a wire.

The electrically conductive track 4 is preferably made of metal, for example, of a material comprising or consisting of Copper or Aluminum or Silver or Gold. The electrically conductive track 4 may, for example, be made of Constantan.

Only one electrically conductive track 4 may be provided (as in the examples shown) adapted to heat the metal tube 5 by induction; or two or more electrically conductive tracks may be provided. For example, an electrically conductive track may be adapted to heat the metal tube 5 by induction, and one or more further electrically conductive tracks may be adapted to act as a sensor, in particular as a capacitive or inductive sensor, for example, to detect the presence of the cigarette in the tube 5.

Preferably, the conductive track 4 also extends about axis Y, preferably completely about axis Y. Advantageously, with the same conductive track 4, it is possible to homogeneously heat the metal tube 5. No further conductive tracks are thus necessary, although possible, for the heating, and therefore the construction of the induction heater is simplified.

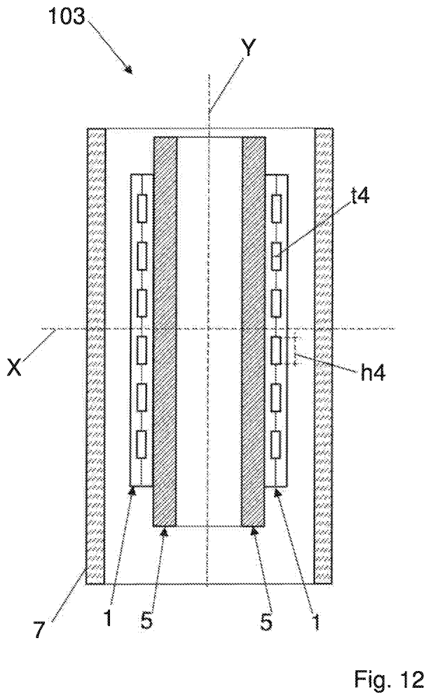

Preferably, in all embodiments, portions of said at least one electrically conductive track 4, in particular different portions, are at different heights with respect to axis Y (as clearly visible, for example, in the FIGS. 4, 8 and 12).

In other words, the conductive track 4 comprises a plurality of portions which are separate from one another, in particular axially separate from one another, along axis Y, or with respect to axis Y (as clearly visible, for example, in FIGS. 4, 8 and 12).

Preferably, in all embodiments, the distance d4 (indicated in particular in FIG. 4) between the track portion closest to a first end of the inductor 1 and the track portion closest to a second end of the inductor 1, opposite with respect to the first end along axis Y, is from 5 to 100 mm.

Preferably, to obtain a better inductive heating, said electrically conductive track 4 has a spiral-like shape. In other words, said electrically conductive track 4 preferably comprises a plurality of turns.

Preferably, different portions of a same turn are at different heights along axis Y.

Preferably, different portions of a same turn are axially separate from one another with respect to axis Y.

Preferably, in all embodiments, the height h4 (indicated in particular in FIGS. 4, 8 and 12), parallel to axis Y, of the conductive track 4 is from 25 to 5000 μm. The height h4 is, in particular, the height of each turn. Optionally, the height h4 is greater than the thickness t4.

Preferably, the pitch between the turns is from 25 to 1000 μm. The “pitch” between the turns is, in particular, the distance between corresponding points of the turns consecutive to one another.

For illustrative purposes, part of an inductor 1 is shown in FIG. 13, where the inductor 1 is arranged on a plane, thus allowing a better view of the spiral shape of the electrically conductive track 4.

Preferably, the electrically conductive track 4 defines a substantially rectangular spiral.

Preferably, the electrically conductive track 4 comprises a plurality of rectilinear stretches 41 and a plurality of curved stretches 42. The rectilinear stretches 41, which are consecutive to one another, are joined together by a respective curved stretch 42.

Said at least one electrically insulating layer 2, 3 is preferably polymeric, for example, said at least one electrically insulating layer 2, 3 may be made of silicone or polyester or polyimide or polyether ether ketone (peek).

Preferably, the inductor 1 comprises two electrically insulating layers 2, 3 between which the electrically conductive track 4 is arranged.

The two electrically insulating layers 2, 3 are preferably polymeric, for example made of silicone or polyester or polyimide or peek. The two electrically insulating layers 2, 3 are sealed to each other, preferably forming a single, substantially monolithic, component.

The electrically conductive track 4 is preferably substantially incorporated in the two electrically insulating layers 2, 3.

Alternatively, a single electrically insulating layer may be provided, for example, layer 3, above which the electrically conductive track 4 is fixed.

The induction heater 101, 102, 103 may comprise only one inductor 1 (as in the embodiments shown in FIGS. 1 to 12), or the induction heater may comprise two or more inductors 1, 1′. In the variant of FIG. 14, which will be further described below, there are, for example, two inductors, i.e., inductor 1 and inductor 1′.

The induction heater 101, 102, 103 may optionally also comprise the metal tube 5.

The metal tube 5 is preferably made of ferromagnetic material. Preferably, the metal tube 5 is made exclusively of metal. Preferably, the metal tube has a cylindrical shape. Preferably, the metal tube 5 is of the non-woven type, in particular the wall of the metal tube is not formed by woven wires. The metal tube 5 may be made, for example, of iron or stainless steel, in particular of ferritic stainless steel.

In all embodiments in which the metal tube 5 is provided, optionally, the inductor 1 and the metal tube 5 may be constrained, in particular fixed, to one another.

With particular reference to FIGS. 1 to 4, a first particular example of induction heater 101 comprises a polymeric tube 6 adapted to be arranged about said metal tube 5.

The inductor 1 is fixed to said polymeric tube 6, preferably to an external surface of said polymeric tube 6. Preferably, the electrically insulating layer 3 of the inductor 1 is directly fixed, preferably it adheres, to the polymeric tube 6. Therefore, the inductor 1, in particular the electrically insulating layer 3, is in contact, in particular directly in contact, with the polymeric tube 6.

The polymeric tube 5 is in particular an element which is distinct from said at least one electrically insulating layer 2, 3.

The polymeric tube 5 may be made, for example, of a material comprising or consisting of ABS, nylon or polypropylene or PEEK.

Preferably, said polymeric tube 6 is spaced apart from said metal tube 5.

In particular, said polymeric tube 6 has an internal diameter which is larger with respect to the external diameter of the metal tube 5.

Preferably, the internal diameter of the polymeric tube 6 is from 5 to 20 mm.

Preferably, the distance d56 between the polymeric tube 6 and the metal tube 5 is from 0.1 to 5 mm.

Preferably, between the polymeric tube 6 and the metal tube 5 there is a space 65, or empty space, which is preferably substantially a duct. The space 65 is preferably annular.

Preferably, and advantageously, said space is adapted to be crossed by a flow of fluid, in particular air or a fluid generated by heating the tobacco.

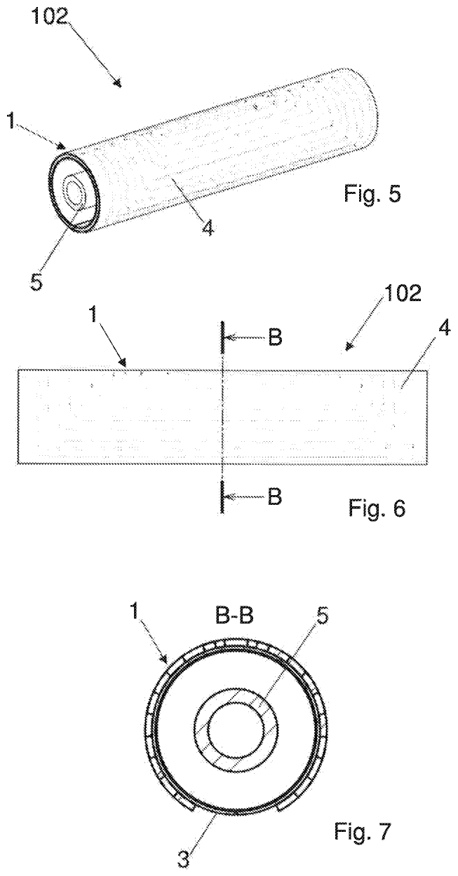

With particular reference to FIGS. 5 to 8, in a second particular example of induction heater 102, the inductor 1 is arranged about axis Y, in particular so as to define a tube, and is spaced apart from said metal tube 5.

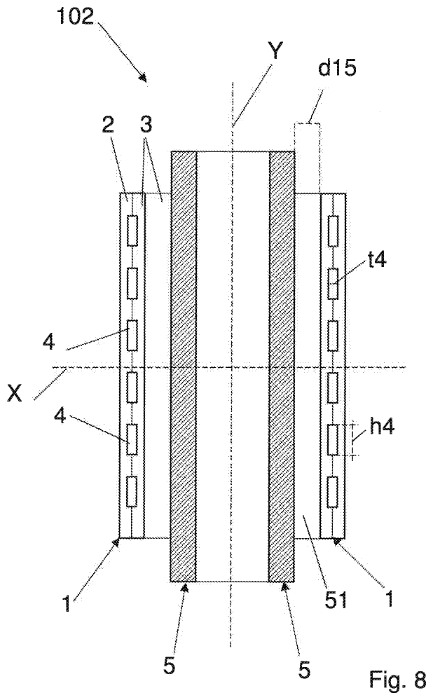

Preferably the distance d15 (FIG. 8) between the inductor 1 and the metal tube 5 is from 0.1 to 5 mm.

Preferably, the internal diameter of the inductor 1 is from 5 to 20 mm. Said internal diameter substantially corresponds to the internal diameter of the electrically insulating layer 3, i.e., the layer proximal to the metal tube 5.

Preferably, between the inductor 1 and the metal tube 5 there is a space 51, or empty space, which is preferably substantially a duct. The space 51 is preferably annular.

Preferably, said space is adapted to be crossed by a flow of fluid, in particular air or a fluid generated by heating the tobacco.

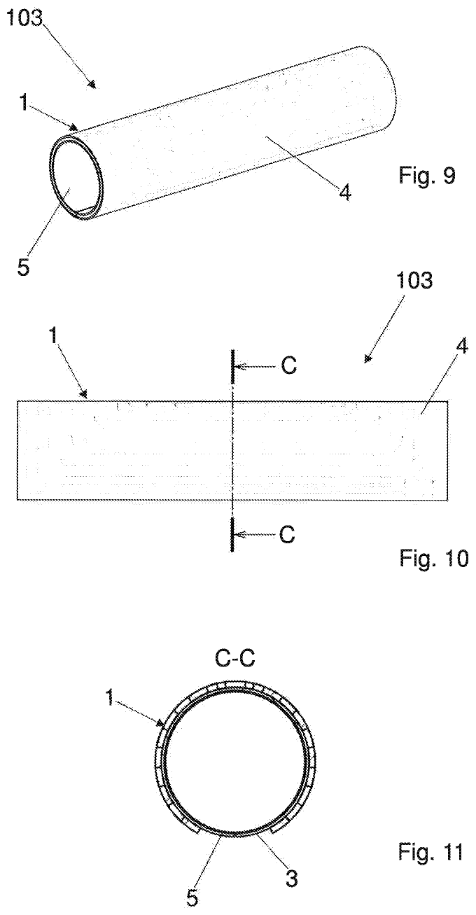

With particular reference to FIGS. 9 to 12, the inductor 1 is fixed to said metal tube 5, in particular to an external surface of said metal tube 5.

Preferably, the electrically insulating layer 3 of the inductor 1 is directly fixed, preferably it adheres, to the metal tube 5. The inductor 1, in particular the electrically insulating layer 3, is in contact, in particular directly in contact, with the metal tube 5.

In particular in this embodiment (although it is also possible in the other embodiments), it is preferable that the induction heater also comprises a duct or tube 7 arranged about the inductor 1 and spaced apart from the inductor 1. In other words, between the tube 7 and the inductor 1 there is an annular space, in particular an empty annular space. Said duct or tube 7 is adapted to be crossed by a flow of fluid, in particular air or a fluid generated by heating the tobacco.

As already mentioned, in all embodiments, the induction heater may comprise more than one inductor 1, although only one inductor 1 may, in any case, be provided. In this case, the induction heaters 1, 1′ are preferably arranged coaxially with respect to one another, in particular about axis Y and along axis Y, in particular at different heights along axis Y. Each inductor 1, 1′ comprises at least one respective electrically insulating layer and at least one respective electrically conductive track.

The inductors 1, 1′ may be substantially identical to one another, or they may be different from one another.

FIG. 14 shows, by way of explanation, a variant of induction heater 101′ according to the first example comprising two inductors 1, 1′.

Preferably, in all embodiments, the induction heater comprises at least one temperature sensor (not shown), in particular adapted to detect the temperature of the at least one inductor.

The invention also relates to a device for heating tobacco or aromatic herbs, in particular of the heat-not-burn type, comprising an induction heater 101, 101′, 102, 103.

Optionally, in all the embodiments, an electric generator is provided, connected or adapted to be connected to said at least one conductive track 4, configured so that the conductive track 4 may function as an inductive element adapted to heat the metal tube 5.

An induction heater 101, 102, 103 is preferably, but not exclusively, manufactured by means of a process in which a component is provided comprising or consisting of said at least one electrically insulating layer 2, 3 and said at least one electrically conductive track 4 fixed to said at least one electrically insulating layer 2, 3, said component having a flat or substantially flat shape (as shown, for example, in FIG. 13). The process involves a step during which said component is deformed, with respect to the flat shape, so that it extends around said axis Y, in particular so as to form a tube or a tubular body, preferably cylindrical.

In particular, said component is flexible.

The component may be optionally fixed to the metal tube 5 or to the polymeric tube 6, as previously described.

In particular, said component is the inductor 1.

1. An induction heater for a device for heating tobacco or aromatic plants or aromatic herbs, in particular of the heat-not-burn type, comprising
at least one inductor extending about an axis and comprising at least one electrically insulating layer and at least one electrically conductive track fixed to said at least one electrically insulating layer;
wherein said at least one inductor is adapted to be arranged about a metal tube in which part of a cigarette or a wrapper may be inserted, in particular containing tobacco or aromatic plants or aromatic herbs; and
wherein the metal tube (5) is adapted to be heated by induction by said at least one inductor.

2. The induction heater according to claim 1, wherein said at least one electrically conductive track has a thickness, parallel to a radial axis with respect to axis, from 5 to 400 μm.

3. The induction heater according to claim 1, wherein said at least one electrically conductive track has a thickness, parallel to a radial axis with respect to axis, from 10 to 400 μm.

4. The induction heater according to claim 1, wherein said at least one electrically conductive track has a thickness, parallel to a radial axis with respect to axis, from 20 to 200 μm.

5. The induction heater according to claim 1 s, wherein said at least one inductor has a thickness, parallel to a radial axis with respect to axis, from 30 to 3000 μm, or from 35 to 3000 μm.

6. The induction heater according to claim 5, wherein said thickness of said at least one inductor is from 30 to 500 μm, or from 35 to 500 μm.

7. The induction heater according to claim 1, wherein said at least one inductor extends about axis so as to define a tube.

8. The induction heater according to claim 1, wherein said at least one electrically conductive track is in a spiral-like shape.

9. The induction heater according to claim 1, wherein said at least one electrically conductive track comprises portions which are separate from one another with respect to said axis.

10. The induction heater according to claim 1, wherein said at least one electrically insulating layer is made of silicone or polyester or polyimide or PEEK.

11. The induction heater according to claim 1, comprising said metal tube; and wherein said at least one inductor is arranged about said metal tube.

12. The induction heater according to claim 11, wherein said at least one inductor is fixed to said metal tube, in particular to an external surface of said metal tube.

13. The induction heater according to claim 11, wherein said at least one inductor adheres to said metal tube, in particular to an external surface of said metal tub.

14. The induction heater according to claim 1, wherein said at least one inductor is arranged about said axis, in particular so as to define a tube, and is spaced apart from said metal tube; preferably by a distance from 0.1 to 5 mm; preferably wherein between said at least one inductor and said metal tube there is a space, preferably wherein said space is adapted to be crossed by a flow of fluid, in particular air or a fluid generated by the heating of the tobacco.

15. The induction heater according to claim 1, comprising a polymeric tube adapted to be arranged about said metal tube (5); wherein said at least one inductor is fixed to said polymeric tube.

16. The induction heater according to claim 15, wherein said at least one inductor is fixed to an external surface of said polymeric tube; preferably wherein said at least one inductor adheres to said external surface of the polymeric tube.

17. The induction heater according to claim 15, wherein said polymeric tube is spaced apart from said metal tube; preferably wherein between the polymeric tube and the metal tube there is a space, preferably wherein said space is adapted to be crossed by a flow of fluid, in particular air or a fluid generated by the heating of the tobacco.

18. The induction heater according to claim 15, wherein said polymeric tube and said at least one electrically insulating layer are distinct from one another.

19. The induction heater according to claim 1, comprising two or more inductors coaxially arranged with respect to one another.

20. The induction heater according to claim 1, comprising at least one temperature sensor adapted to detect the temperature of the at least one inductor.

21. The induction heater according to claim 1, comprising a duct or tube arranged about said at least one inductor and spaced apart from said at least one inductor; said duct or tube being adapted to be crossed by a flow of fluid, in particular air or a fluid generated by the heating of the tobacco.

22. The induction heater according to claim 1, comprising at least two electrically conductive tracks, of which at least one electrically conductive track is adapted to heat the metal tube (5) by induction; and at least one electrically conductive track is adapted to act as a sensor, in particular as a capacitive or inductive sensor.

23. A device for heating tobacco or aromatic plants or herbs, in particular of the heat-not-burn type, comprising the induction heater according to claim 1.

24. A process for manufacturing an induction heater according to claim 1, wherein a component is provided comprising or consisting of said at least one electrically insulating layer and said at least one electrically conductive track fixed to said at least one electrically insulating layer, said component having a flat shape; wherein a step is provided during which said component is deformed so that it extends about said axis, in particular so as to form a tube or tubular body.
